(19) United States
(12) Patent Application Publication
(10) Pub. No.: US 2011/0153169 A1
(43) Pub. Date: Jun. 23, 2011

(54) Sensor-Based Implement Motion Interlock System

(75) Inventor: John Peterson, Jackson, MN (US)

(73) Assignee: AGCO CORPORATION, Duluth, GA (US)

(21) Appl. No.: 12/642,077

(22) Filed: Dec. 18, 2009

(51) Int. Cl. G06F 7/00

(52) U.S. Cl. 701/50

(57) ABSTRACT

In an example embodiment, a sensor based implement motion interlock comprises, a sensor for detecting an obstacle near the implement and a controller configured to stop movement of the implement when the obstacle is detected. An override switch may be provided to allow an operator to move the implement in a safe mode after the object is detected. The override switch may be positioned to ensure that the operator is cognizant of the obstacle during movement of the implement. A normal mode of operation may be resumed when the object is no longer in proximity and/or an operation of the implement is complete.

### TECHNICAL FIELD

The present invention relates generally to agricultural vehicles, and more particularly to sensor-based systems that control movement of an attached implement.

### BACKGROUND OF INVENTION

Global competition compels farmers to modify cultivation practices by incorporating more cost-effective farming techniques and acquiring more efficient machinery. In doing so, farmers have increasingly turned to larger machinery and more sophisticated technology that automates and optimizes the operation of agricultural vehicles and equipment. Liquid and dry air boom type crop applicators have been used to apply a variety of crop inputs, such as fertilizer, nutrients, seed and crop protectants, herbicides, insecticides, and the like in site specific farming applications. Agricultural vehicles can apply crop inputs based on algorithms that incorporate geographical information as well as soil data, crop data, and the like to determine the amount and placement of crop inputs needed to maximize crop production. To decrease the number of passes needed to traverse an entire field, farmers have turned to implements with increased widths, and booms extending 90 feet or more in width can now be employed. Extended booms are manufactured in hinged sections that can be individually controlled by a system of hydraulic cylinders to allow manipulation of individual sections. Sections can be extended outward at various angles or be folded inward to avoid obstacles or minimize the space needed to store the vehicles. In addition to lateral control of the boom sections, vertical control of the boom sections can also be exercised.

Boom sections can be manually raised or lowered by an operator. However, manually controlled boom operations are subject to human factor errors. Operators may not have an unobstructed view of the field and/or air space surrounding them. In addition, operators may have delayed reaction times that prevent them from manipulating the booms quickly enough to avoid obstacles. Furthermore, operators of agricultural vehicles are often inexperienced and have little training in regards to the potential hazards of operating such equipment.

Many agricultural vehicles are equipped with an array of sensors that can provide information about the distance between the implement and the ground. For example ultrasonic sensors aimed at the ground below the boom can emit pulses and determine distance to the ground by measuring the time it takes to receive an echo. While useful for detecting masses such as the ground or large obstacles, ultrasonic sensors may not be as effective in detecting targets with small cross-sections, or obstacles in the air space above the vehicle.

Of particular concern are contacts with power transmission lines. There are many occasions when an operator or automatic boom control system will raise the implement in order to avoid an obstacle or incline on the ground, or to configure the vehicle for roadway travel. The area in front of the operator may appear clear, and the operator may not be aware that a boom lifting procedure may bring the boom in contact with a power line. Power lines can vary in the voltage and current levels that they transport, and a high tension power line may operate at 110,000 volts. With implement spans of 90′ or more, implement wings may inadvertently cross power lines during an elevation procedure. Contact with power lines can be lethal. In addition to posing a hazard to agricultural vehicle operators, power lines can also damage the agricultural machinery itself. Furthermore, fellow workers or bystanders can be electrocuted or shocked by touching charged equipment or downed power lines, or while attempting to assist someone who has been electrocuted.

### SUMMARY OF THE INVENTION

The present invention provides systems and methods for controlling implement movement in the presence of an obstacle, such as by way of example and not limitation, an electric power line. An example system can include at least one sensor adapted to detect the presence of an object, such as an electrical transmission line, an alarm module configured to receive input from the at least one sensor and provide an alarm status; and a controller configured to check the alarm status at the alarm module and prevent implement motion when the alarm status indicates that the object is present. An example system can further include an operator override switch by which an operator can move the boom when the alarm status indicates the detection of an object, such as a power line. In an example embodiment, boom motion in response to an override switch is performed in a safe mode at a slower than normal rate. The safe mode may be exited once the operation is complete, the object is cleared, the object is no longer in proximity, or upon the occurrence of some other event. For example, the boom motion can be performed at an incremental rate to allow the operator to carefully observe the motion and avoid accidental contact with the object. Once the implement is no longer in proximity of the object then a normal rate of motion may be resumed.

### BRIEF DESCRIPTION OF THE DRAWINGS

FIG. 1 shows a perspective view of an example embodiment of a vehicle with a sensor-based motion interlock system.

FIG. 2 depicts a schematic diagram of an example embodiment of a sensor-based motion interlock system.

FIG. 3 depicts a block diagram of an example embodiment of a sensor-based motion interlock system.

FIG. 4 depicts a vehicle cab in which a sensor-based motion interlock system is installed.

FIG. 5 depicts an example embodiment of a flow diagram for a sensor-based motion interlock system.

FIG. 6 shows a logic block diagram indicating various combinations of inputs and operational outcomes of a sensor-based motion interlock system.

### DETAILED DESCRIPTION OF EXAMPLE EMBODIMENTS

As required, example embodiments of the present invention are disclosed herein. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. The example embodiments are discussed in the context of an object in the form of electrical power lines but it will be understood that the invention may also be used for detecting and responding to the proximity of other objects. In addition, whereas in the example embodiment, the implement is discussed in the context of a boom sprayer on a spray vehicle, other arrangements could be employed such as an arrangement including a header or other implement.

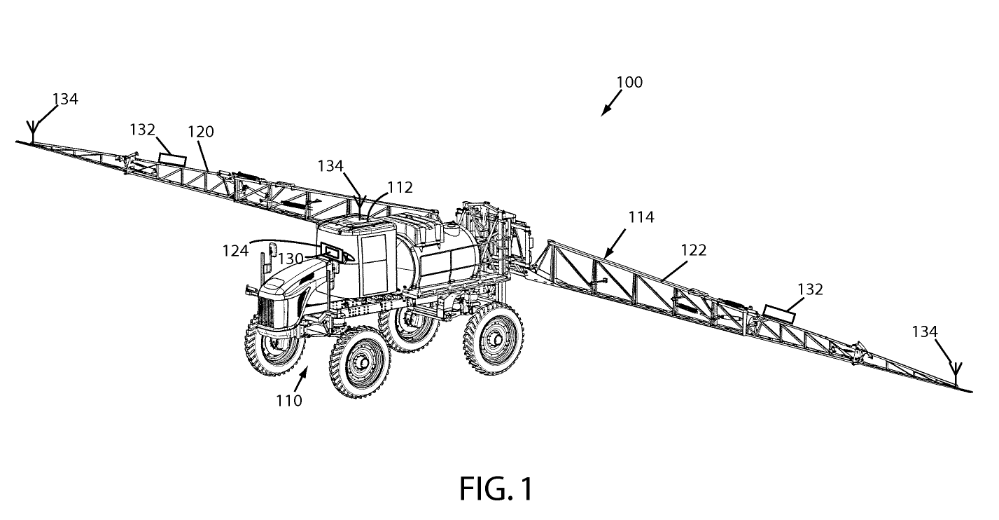

Turning to the figures, wherein like numbers represent like elements throughout the several views, FIG. 1 shows an example embodiment 100 of a vehicle having a sensor-based implement motion interlock system, that comprises an agricultural vehicle 110 having a cab 112, and an implement 114, comprised of a left wing 120 and a right wing 122. For example, the implement 114 can be in the form of an extended boom equipped with a sprayer device. Within the cab 112 is a controller 124 and an alarm module 130. The controller 124 can be a computer or a processor such as an ARM processor and be configured to interact with other control units that may be present at the vehicle 110. Sensors 132 are positioned on the left and right implement wings 120, 122 and configured to detect the presence of an object, such as a ground obstacle, a fence, a building, a vehicle, or an electric power line in the vicinity of the vehicle 110 and, in response, provide input to the alarm module 130 via an antenna 134.

The alarm module 130 can be configured to provide an alarm status that indicates whether input indicating the presence of an object, such as a power line, has been received. The controller 124 can be configured to check the alarm status at the alarm module 130, and inhibit boom operation when a power or transmission line is detected.

In addition, an override may be required for continued operation of the boom. For example, an override switch may be provided in the cabin 112 of the vehicle 110 at a location that requires the operator to take sufficient physical action that the operator will have the implement 114 in sight. For example, the override may be positioned within the cabin 112 of the vehicle 110 so that the operator must turn in the direction of the implement 114.

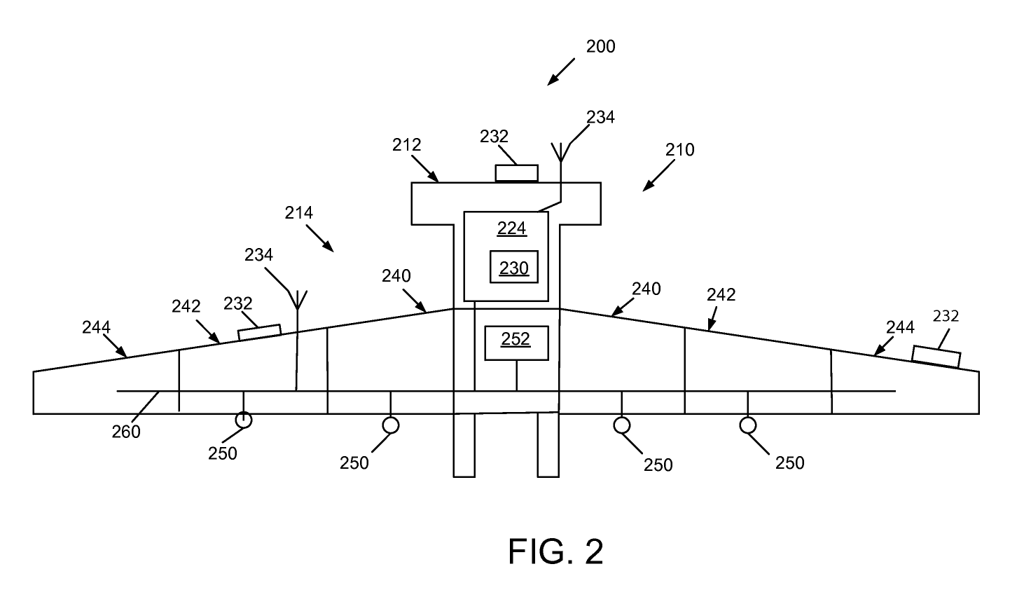

FIG. 2 depicts an exemplary embodiment 200 of a vehicle employing a sensor-based motion interlock system, comprising an agricultural vehicle 210 having a cab 212 and an implement in the form of a boom 214. Within the cab 212 there is a controller 224 and an alarm module 230. In an example embodiment the agricultural vehicle 210 can be an input applicator vehicle such as the Terra-Gator® and RoGator® manufactured by AGCO Corp. In an example embodiment, the boom 214 can be in the form of a crop applicator boom structure comprising a plurality of hinged sections that can be individually manipulated while navigating a field, or when preparing to configure the vehicle for travel on a road.

The boom 214 can comprise one or more inner sections 240, one or more intermediate sections 242 and one or more tip sections 244. Adjacent boom sections can be movably connected to one another, and be pivotable about a boom pivot point. Boom sections 240, 242 and 244 can be maneuvered by boom actuators 250 that can comprise hydraulic cylinders controlled hydraulically by hydraulic valves. For example, boom actuators 250 may be positioned proximate boom pivot points and be electronically controlled by a Boom Control Unit (BCU) 252. The boom actuators 250 can be configured to move the boom 214 vertically and horizontally as known in the art.

One or more sensors 232 can be positioned on the vehicle 210 to detect the presence of electrical power lines. Although depicted with two sensors 232 disposed on the boom 214 in the example embodiment 200 and one sensor 232 disposed on the cab 212, fewer or more sensors 232 may be positioned at various locations on the vehicle 210. In a preferred embodiment, the sensors 232 comprise one or more power line sensors that detect the presence of an electromagnetic field, and convert the electromagnetic field to energy. For example, High Voltage Detection System sensors available from Transport Support of the United Kingdom may be used. The energy in turn powers electronics that transmit a signal to the antenna 234, thus providing a wireless means of providing a warning signal that an electrical power line has been detected. Additional information regarding power line sensors can be obtained from U.S. Patent Application No. 60/982,184 filed on Oct. 24, 2007, which is incorporated in its entirety herein by reference. In an example embodiment, where the boom 214 has a width of 60′ to 80′ the sensors 232 may be configured to detect an electromagnetic field within about 20 feet of the vehicle 210, but the sensors 232 could be configured to detect objects at other distances. For example, for a 176′ boom a buffer of 200′ may be used whereas a 50′ cultivator may have a 70′ buffer or sphere. Sensor input received at the antenna 234 can be provided to the alarm module 230. As shown in FIG. 2, the sensor 232 and antenna 234 can be mounted on the cab 212, the boom 214 or anywhere on the vehicle 210. The antenna 234 can be coupled to the controller 212 or the alarm module 230 directly or via data bus 260.

The controller 224, the BCU 252 and the actuators 250 can be communicatively coupled by a data bus 260. Preferably, the bus 260 is a controller area network (CAN) bus such as that developed by BOSCH and based on the International Organization for Standardization (ISO) 11783 protocol for agricultural vehicles. A CAN bus is a high-integrity serial data communications bus used for real-time control applications. The CAN bus is described in greater detail in “ISO 11783: An Electronic Communications Protocol for Agricultural Equipment”, ASAE Distinguished Lecture #23, Agricultural Equipment Technology Conference, 7-10 Feb. 1999, Louisville, Ky. USA, ASAE Publication Number 913C1798, which is incorporated herein in its entirety by reference.

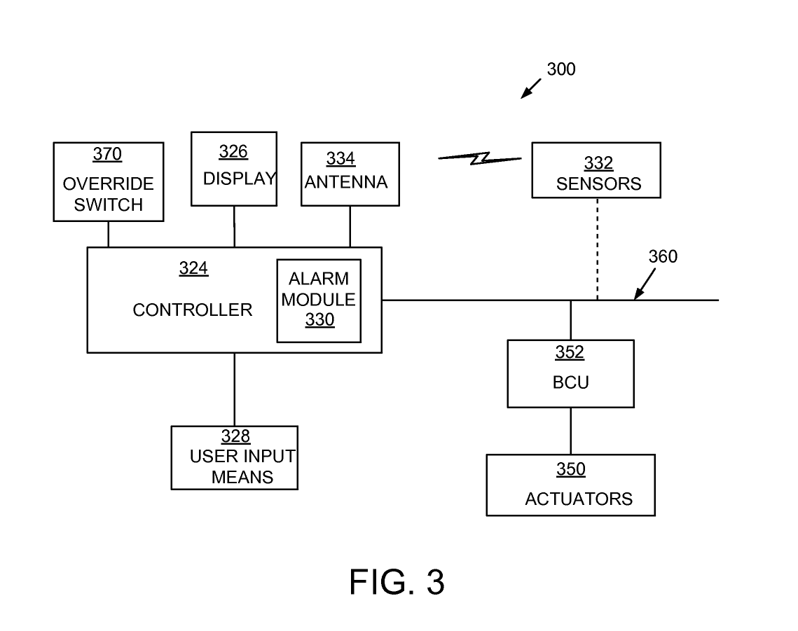

FIG. 3 shows a block diagram of an example system 300. The controller 324 can function as a host computer that can work in combination with various control systems and sensors, such as those employed on an agricultural vehicle. For example, a Falcon® variable rate control system manufactured by AGCO Corporation may be used control application of crop products, with the Falcon software executed by the controller 324. Similarly, a ViperPro guidance system developed by Raven Industries may be employed for providing guidance control in conjunction with a DGPS receiver. While the ViperPro system may utilize a separate user console, the controller 324 may cooperate with the ViperPro system so that ViperPro guidance screens may be viewed on a display 326 coupled to the controller 324.

The controller 324 can be coupled to a user input means 328 which can include one or more input means such as a keyboard, mouse, joystick, console, or other input means as known in the art. The user input means 328 can provide a means by which an operator can select a desired boom operation, such as a lifting procedure. For example, the user input means 328 can comprise a console having a plurality of buttons, each associated with a particular boom maneuver.

The example system 300 further includes an alarm module 330. The alarm module 330 can comprise software, hardware, firmware or a combination thereof. Although shown as a module installed on the controller 324, it is contemplated that the alarm module 330 can be a stand-alone module communicatively coupled to the controller 324, or comprise a receiver at an antenna 334. Thus, input from the antenna 334 can be received at the alarm module 330 via the processor 324, via a direct connection, by data bus or by other means (not shown) within the system 300.

In an example embodiment, the alarm module 330 can be configured to receive sensor 332 input from one or more antenna 334 and indicate an alarm status based on the sensor input. In an example embodiment, the sensor 332 comprises one or more power line sensors. Alarm status can be indicated in various ways. For example, an alarm value can be maintained at the alarm module 330. The alarm value can be set to 0 or LOW when no input indicating the presence of a power line has been received, and the alarm status would accordingly be “no alarm”. When transmissions are received by the antenna 334 that indicate the presence of a power line, the alarm value can be set to 1 or HIGH, and the alarm status would accordingly be “alarm present”. Other methods of providing alarm status will occur to those skilled in the art. For example, in lieu of setting an alarm value, the alarm module 330 can be configured to simply store a record of sensor input so that if any input is present, the alarm status can be determined from a query of the alarm module to be “alarm present”, and is “no alarm” when no input is present. In a further example embodiment, a plurality of alarm modules 330, for example stand alone alarm modules, each associated with one or more sensors can be coupled to the controller 324 via the data bus 360, or other means, allowing the controller 324 to query each one to determine whether an alarm is present. While the sensor 332 is shown as a wireless sensor that sends a signal to the antenna 334, the sensor 332 could be wired into the databus 360 to provide signals to the alarm module 330 directly as shown by dashed line in FIG. 3.

The controller 324 can be communicatively coupled to a boom control unit (BCU) 352 via the data bus 360, which is preferably a CAN data bus. As discussed above, the BCU 352 can control vertical and lateral movement of the boom sections 240, 242 and 244. The BCU 352 can be coupled to actuators 350 which can include valves, electric motors, belts, pumps, or other similar devices that can be used to lift, tilt, lower or otherwise manipulate one or more boom sections. For example, the actuators 350 can include valve assemblies associated with hydraulic cylinders that can provide the required force to move a boom section in a desired direction. Although the example system 300 is shown as having only a single BCU 352, it is understood that a plurality of BCU's may be disposed along the width of the boom to provide the proper boom control for each boom section.

In an example embodiment, the controller 324 is configured to stop or prevent boom motion when an “alarm present” status at the alarm module 330 indicates that a power line has been detected. The controller 324 can be configured to receive boom motion input from a user, and direct the BCU 352 in accordance with the user input. For example, when a user selects a button corresponding to lifting the right boom wing, a command is sent to the BCU 352 to lift the right boom wing. In an example embodiment, when an alarm is present, the controller 324 can be configured to withhold or suspend that command, so that no directions are sent to the BCU 352 to execute the maneuver, and accordingly, no motion occurs. In an example embodiment, the controller 324 can inhibit boom motion by providing a stop motion command to the BCU 352 via the data bus 360, so that if movement was initiated in response to boom motion input, the movement is stopped. The BCU 352 can stop the elevation, lowering, tilting, folding, or other motion of an implement or section thereof, by controlling the actuators, such as hydraulic valve assemblies, associated with one or more boom sections. Alternative ways of stopping or preventing implement motion when the alarm status at the alarm module 330 indicates that an alarm is present will occur to those skilled in the art. For example, electrical actuation or the use of an actuation control signal may be used as will be apparent to one of skill in the art.

The controller 324 can also be communicatively coupled to an override switch 370. The override switch 370 can be configured to allow an operator to override the stop motion command provided by the controller 324, so that a boom can be moved while the alarm status at the alarm module 330 indicates that an alarm is present. Preferably boom motion that is conducted after the override switch has been depressed is performed in a safe mode, at a slower rate than the normal operational rate. When the override switch 370 is depressed, the safe mode may be engaged so that the implement moves in steps or at a reduced speed to allow for careful operation of the implement and allow the operator sufficient control over the implement to avoid unwanted contact with the obstacle. For example, the boom movement can be performed at an incremental rate, allowing the operator to carefully observe the motion and halt the motion manually if necessary to avoid an accident. Once the operation is completed and/or the object is cleared then normal operation of the implement can recommence. For example, the sensors 332 may no longer detect the obstacle so that the alarm module 330 can remove the alarm state and return to a normal mode.

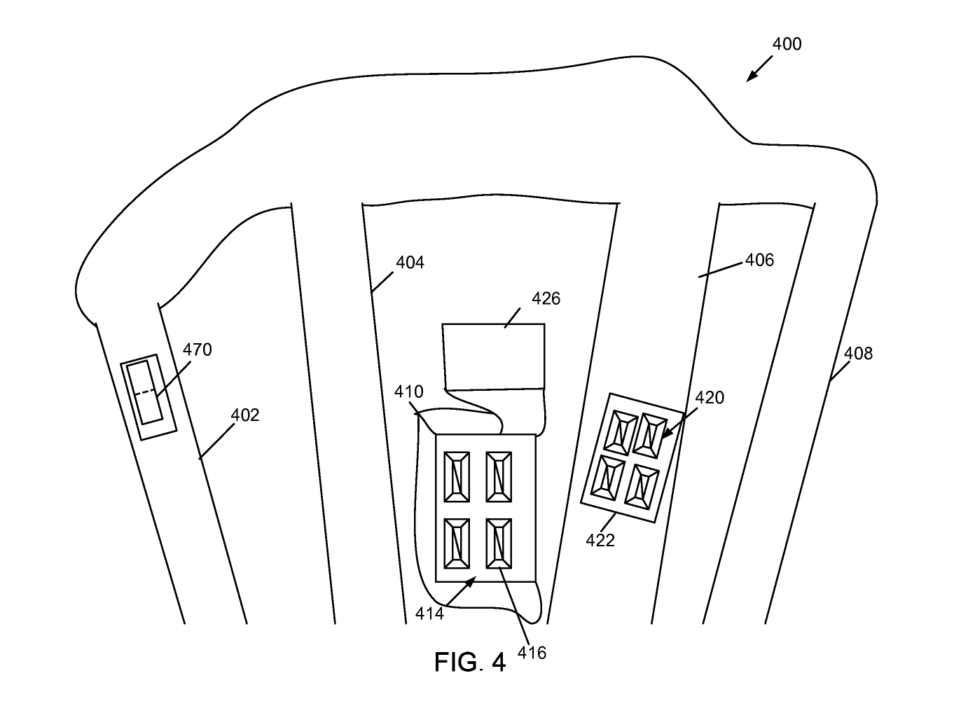

FIG. 4 shows an example embodiment of a portion of a vehicle cab 400 having four pillars, 402, 404, 406 and 408. The cab 400 may have more than four pillars, such as a six pillar cab found in a RoGator® vehicle, but only four pillars are shown in FIG. 4. A user console 410 is mounted between posts 404 and 406 which may be positioned in front of an operator's seat (not shown) so that the operator's primary field of vision when operating the vehicle is between pillars 404 and 406 when facing forward in the operator's seat. The user console 410 can include a set of boom motion buttons 414 which can be individually selected by an operator to control boom operation. The user console 410 can be coupled to a display 426 which can be configured to display information and user interface screens to an operator. For example, the display 426 can provide information to an operator in response to a user's selection of one of the buttons 414, or provide error messages to an operator. Preferably the display 426 can display information to an operator regarding boom or implement operations. A post console 420 having set of selectable buttons 422 can be mounted on one of the posts 402-408, as shown on post 406 in FIG. 4, providing additional user input means for controlling boom operation. The console 420 can be associated with and interact with a computer, such as the controller 224, and/or with a control system such as the ViperPro system discussed earlier herein.

An override switch 470 is provided on post 402 to allow an operator to override a stop boom motion command. Although described as a switch, it is understood that the override switch 470 can be variously embodied as a button, lever, or other user input means. It is preferable that the override switch 470 be disposed apart from the primary consoles 410 and 420 to prevent inadvertent depression of the switch. In addition, it is preferable that the switch be located in a cab location that requires an operator to turn his head in order to access the switch, so that the implement 114 is within his direct or peripheral vision when he depresses the switch. As shown in FIG. 4, the override switch can be mounted sufficiently high on the post 404 that it is not likely to be accidentally flipped or depressed while the operator is entering the cab or performing routine tasks. While shown in the example embodiment of FIG. 4 on a left pillar 402, in an alternative embodiment the override button 470 may be provided on a rear pillar of a six pillar cab, i.e., a C-pillar, such that the operator must move from a forward looking position in the operator's seat (not shown) to a somewhat rearward position so that the boom 214 is in the operator's view.

Furthermore, the override switch 470 may be positioned so as to require the operator to turn in or get up from the operator's seat. For example, the override switch 470 may be positioned out of the normal reach of an operator sitting in a standard operating position in the operator's seat. In addition, the override switch 470 may be used in conjunction with a seat sensor (not shown) that detects whether the operator is sitting in the operator's seat. Such seat sensors are known in the art. For example, to allow movement of the implement when an obstacle is detected, may require both the pressing of the override switch 470 by the operator and an indication via the seat sensor that the operator is not sitting in the operator's seat. This helps ensure that the operator is cognizant of the situation and has view of the implement 114 during the override and/or alarm mode.

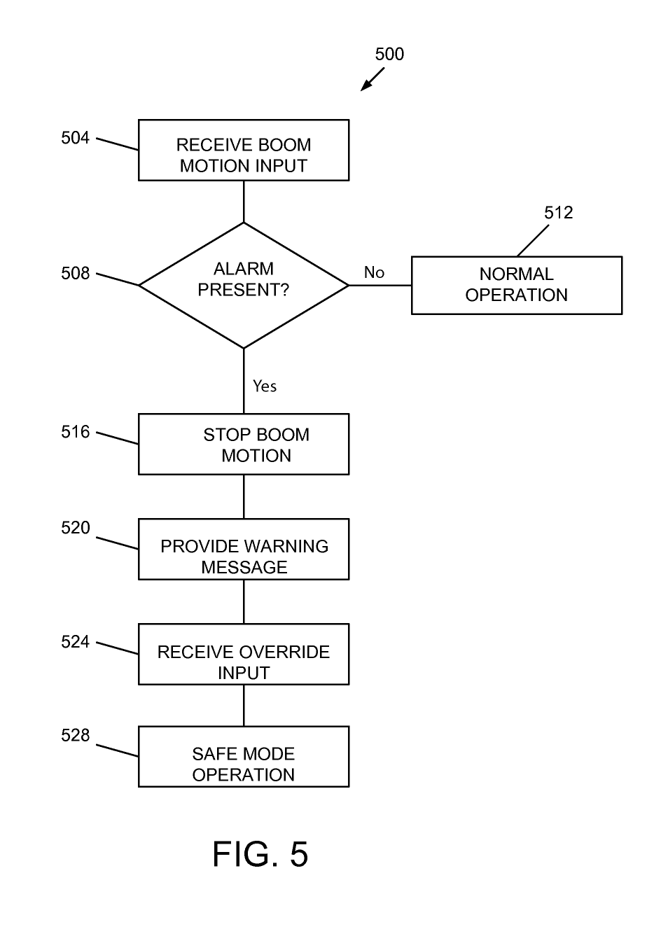

FIG. 5 depicts a flow diagram of an example method 500 that can be practiced by a system of the invention. At block 504, boom motion input can be received. For example, an operator can depress at least one of the buttons 414 on console 410 or at least one of the buttons 422 on console 420 to initiate some form of boom motion. As an illustrative example, an operator can press boom motion button 416, which is associated with lifting left boom wing section 120.

At block 508 a determination is made as to whether an alarm is present. As discussed earlier, an alarm is present when sensor input has been received indicating that a power line has been detected. In an exemplary embodiment, the alarm status at the alarm module 330 can be checked. For example, if an alarm value at the alarm module 330 is HIGH then an alarm is present due to received warning transmissions from one or more power line sensors. As an alternative to checking an alarm value, the alarm module 330 can be checked for sensor input. In an example embodiment, the alarm module 330 can be configured to store reception of detection/warning transmissions, as well as identification of the sensors that transmitted them. For example, the alarm module 330 can comprise a database or memory indexed by sensor so that an alarm status can be determined by checking whether input has been received from a sensor. In a further example, the alarm module 330 can be in the form of a receiving means coupled to the antenna 334. Alarm status can be ascertained by the controller 324 by checking whether input from the sensors 332 is being received at the alarm module 330.

If no alarm is present, the method can continue at block 512, and boom motion can proceed as normal in accordance with the boom motion input received at block 504; i.e. the boom motion associated with motion button 416 is performed. For example, the controller 324 can provide the boom motion input, or instructions based on the received boom motion input, to the BCU 352 via the bus 360. The BCU can command the actuators 350 to move the boom accordingly, at the normal operational speed.

If the alarm status is high, i.e. a power line has been detected, then boom motion can be stopped or locked at block 516. In an example embodiment, the controller 324 can provide a stop motion command to the BCU 352 via the bus 360. In response to receiving the stop motion command, the BCU 352 can halt boom movement through control of the actuators 350.

At block 520 a warning message can be displayed to the operator to inform him that boom motion has been terminated. For example, a warning message can be displayed at the display 326. The warning message can also include information such as the reason the motion was stopped, and, in an example embodiment, which sensor provided a warning signal, such as the “power line sensor on the right boom tip” prompting the operator to look towards the right boom tip to see the power line. In addition to a visual warning message, an audible alarm can also be provided to the operator. When an audible alarm means is provided, it is contemplated that an alarm muting means can also be provided so that an operator can mute the audible alarm if desired. After receiving the warning message, the operator can choose to move the vehicle 210 away from the power line and then attempt the boom maneuver again by pressing one of the buttons 416 or 422, to restart the process at block 504.

In an exemplary embodiment, when the antenna 334 no longer receives any power line sensor transmission, the alarm module 330 no longer indicates that an alarm is present. For example, an alarm value can be set to 0 whenever no transmissions are being received. Records of sensor transmissions maintained in a database or memory can be cleared when the particular sensor is no longer transmitting. When embodied as a receiver, a check of the alarm module will show no sensor input being received, indicating a “no alarm” status. Accordingly, if the vehicle 210 is moved to a safe distance from any power line, beyond the detection distance or threshold of the power line sensors, no warning transmissions will be received, and the alarm status at alarm module 330 will be “no alarm”. Therefore, in response to receiving boom motion input at block 504, no alarm will be present at decision block 508 and boom motion will be allowed to proceed at block 512.

After receiving an alarm message at block 520, an operator also has the option of overriding the automatic termination of boom movement by selecting or depressing an override switch 470. In an example embodiment, an operator must depress the override switch 470 while simultaneously depressing a boom motion button or other boom motion input means in order to move the boom. For example, referring to FIG. 4, an operator can hold down boom motion button 416 while depressing the override switch 470; this action causes override input to be received at block 524. In response to receiving override input, boom motion can be performed in a safe mode at block 528. For example, override input from the switch 470 and motion input from the motion button 416 can be received at the controller 324. In response, the controller 324 can provide one or more motion commands to the BCU 352 via the data bus 360. In an example embodiment, the one or more motion commands can comprise a command to operate in a safe mode while performing the task associated with motion button 416. In an example embodiment, a safe mode differs from a normal operational mode in that boom movement is performed at a greatly reduced rate, or in incremental steps, so that an operator visually observing the procedure has the time and opportunity to halt the motion if he so desires. Operation can continue in the safe mode until the desired implement maneuver is completed and boom motion terminated by the operator.

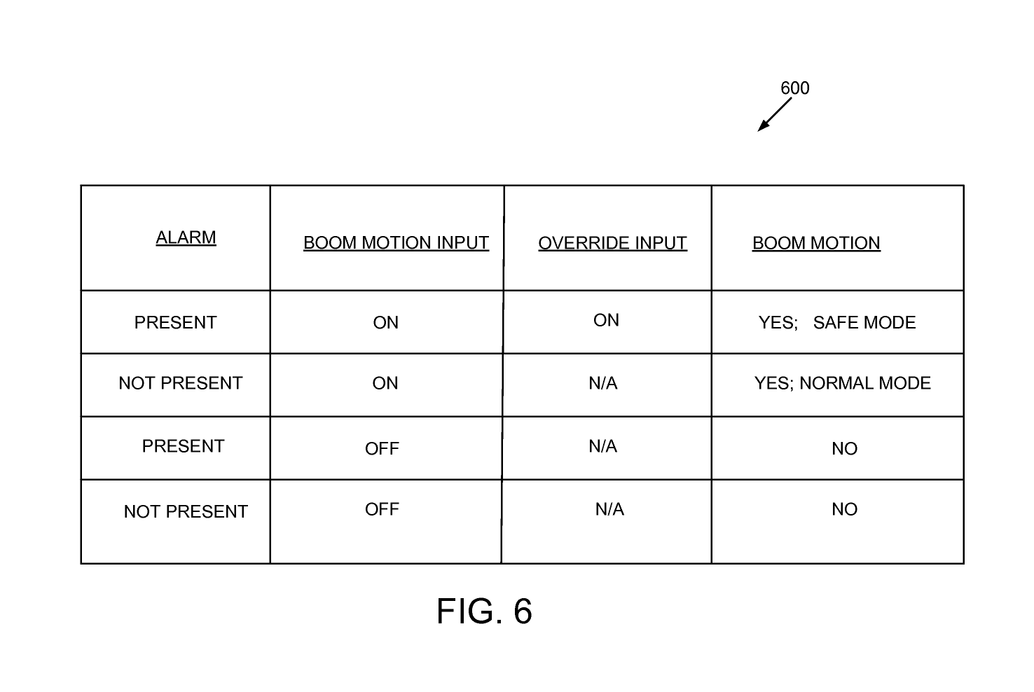

Thus the controller 324 can receive input from operator boom motion buttons, an operator override button and an alarm module 130 to control boom motion in a manner that is safe for the operator, bystanders and the equipment itself. Various combinations of inputs can result in various operational outcomes, as shown in FIG. 6, which depicts an outcome chart for an example embodiment 600. The letters N/A in the chart stand for “not applicable”. As gleaned from chart 600, when an alarm is present, a boom motion switch, such as button 416 is ON and an override switch, such as switch 470, is ON, boom movement can proceed in a safe mode. When the alarm status is not present and a boom motion switch is ON, boom motion can proceed in a normal mode. When an alarm is present and the boom motion switch is OFF, there is no boom movement. Finally, when there is no alarm and the boom motion switch is OFF, there is no boom motion.

Thus, the present invention provides systems and methods for stopping implement motion when an electrical transmission line is detected within the vicinity of an agricultural vehicle. By automatically halting boom movement procedures when an electric field is detected, accidental encounters with power lines can be avoided, protecting lives and equipment. An override option is available to an operator, allowing him to conduct a boom maneuver even though a power line is within his environs. Preferably, the override option allows boom movement in a safe mode, at a much slower rate than normal operations.

In the example systems discussed herein, power line sensors that detect an electric field and convert the field to energy which powers transmitting electronics have been identified as example sensors that can be deployed. However, as those skilled in the art will appreciate, the invention is not limited to a particular type of sensor, rather any sensor configured to detect the presence of a power line can be used. It is not essential that a sensor be wireless, as the sensors can be communicatively coupled to the controller 224 or alarm module 230 by a communications or data bus, such as the bus 260. Furthermore, it is contemplated that a system of the invention need not be limited to agricultural vehicles or power line detection. For example sensors other than power line sensors can be deployed and used to detect the presence of objects or obstacles within the vicinity of a machine. Machine operations can be automatically halted when an obstacle is within a predetermined distance of the machine. Additional applications will occur to those skilled in the art.

Thus, although the invention has been discussed with respect to specific embodiments thereof, the embodiments are merely illustrative, not restrictive of the invention. Numerous specific details are provided, such as examples of components and methods, to provide a thorough understanding of the invention. One skilled in the relevant art will recognize, however, that an embodiment of the invention can be practiced without one or more of the specific details, or with other apparatus, systems, methods, components and/or the like. In other instances, well-known structures or operations are not specifically shown or described in detail to avoid obscuring aspects of embodiments of the present invention. Reference throughout this specification to “one embodiment”, “an embodiment”, “example embodiment”, or “specific embodiment” does not necessarily reference the same embodiment, and furthermore means that a particular feature, structure or characteristic described in connection with the embodiment is included in at least one embodiment of the present invention but not necessarily in all embodiments. It will also be appreciated that one or more of the elements depicted in the drawings can also be implemented in a more separated or integrated manner, or even removed as is useful in accordance with a particular application. As used in the description herein and throughout the claims that follow, “a”, “an” and “the” include plural references unless the context dictates otherwise.

Thus, while the present invention has been described herein with reference to particular embodiments thereof, latitude of modifications, various changes and substitutions is intended in the foregoing descriptions. It is understood that the invention is not to be limited to the particular terms used in the following claims, but that the invention will include any and all embodiments and equivalents falling within the scope of the appended claims.

What is claimed:

1. An apparatus for controlling motion of an implement of an agricultural vehicle, comprising:
at least one sensor configured to detect presence of an object; and
a controller configured to inhibit motion of an implement of the agricultural vehicle upon detection of the object.

2. The apparatus of claim 1, wherein the sensor is configured to detect the presence of an electrical power line.

3. The apparatus of claim 1, further comprising:
an alarm module configured to receive input from said sensor and generate an alarm status.

4. The apparatus of claim 1, further comprising:
an alarm module configured to receive input from said sensor and generate an alarm status, and wherein the controller is configured to check said alarm status and inhibit motion of the implement when said alarm status indicates the presence of said object.

5. The apparatus of claim 1, further comprising an override to allow movement of the implement.

6. The apparatus of claim 1, further comprising:
an override configured to receive input from an operator to allow movement of the implement and wherein said controller is configured to command a safe mode operation in response to said override input.

7. The apparatus of claim 6, wherein said override comprises a switch located outside a standard operator work station of the agricultural vehicle.

8. The apparatus of claim 6, wherein said override comprises a switch located within a cab of the agricultural vehicle at a location requiring an operator to leave an operator seat of the agricultural vehicle.

9. The apparatus of claim 1, further comprising an implement control unit communicatively coupled to said controller and configured to control motion of the implement by controlling actuators configured to move at least a portion of said implement.

10. The apparatus of claim 1, further comprising means for receiving implement motion input from an operator.

11. The apparatus of claim 1, wherein said sensor is configured to detect an electromagnetic field.

12. A method for controlling an implement of an agricultural vehicle, comprising:
detecting the presence of an object within proximity of the agricultural vehicle; and
inhibiting motion of an implement of the agricultural vehicle when said obstacle is detected.

13. The method of claim 11, wherein said detecting the presence of an obstacle within proximity of the agricultural vehicle, comprises detecting an electrical power line.

14. The method of claim 11, further comprising:
generating an alarm when the obstacle is detected.

15. The method of claim 11, further comprising:
receiving an override input; and
allowing motion of the implement in response to the override input.

16. The method of claim 11, further comprising:
detecting that the object is not in proximity to the implement; and
allowing motion of the implement.

17. The method of claim 11, further comprising:
receiving an override input; and
allowing motion of the implement in a safe mode in response to the override input.

18. The method of claim 11, further comprising:
receiving an override input;
allowing motion of the implement in a safe mode in response to the override input;
detecting that the object is not in proximity to the implement; and
allowing motion of the implement in a normal mode.

19. The method of claim 11, further comprising:
detecting that a task has been completed; and
allowing motion of the implement.

20. A method for controlling motion of an implement, comprising:
receiving input regarding motion of an implement; and
checking an alarm status at an alarm module, the alarm status of the alarm module configured to change status upon presence of an object in proximity of the implement.

21. The method of claim 20, further comprising controlling operation of the implement in accordance with said alarm status.

22. The method of claim 20, further comprising preventing implement motion when said alarm status indicates detection of an obstacle.

23. The method of claim 20, further comprising providing a warning that implement motion is inhibited at a display device.

24. The method of claim 20, further comprising providing an audible alarm.

25. The method of claim 20, further comprising receiving override input from an operator.

26. The method of claim 20, further comprising directing implement operation in a safe mode when an override input and implement motion input are received simultaneously.

27. The method of claim 26, wherein said safe mode comprises moving said implement at a slower rate than a normal rate performed in response to receiving implement motion input without receiving the override input.
